(19) United States
(12) Patent Application Publication
(10) Pub. No.: US 2026/0095056 A1
(43) Pub. Date: Apr. 2, 2026

(54) SECONDARY BATTERY PROTECTION INTEGRATED CIRCUIT AND BATTERY DEVICE

(71) Applicants: Takeshi YAMAGUCHI, Tokyo (JP); Shingo KUBOTA, Tokyo (JP)

(72) Inventors: Takeshi YAMAGUCHI, Tokyo (JP); Shingo KUBOTA, Tokyo (JP)

(73) Assignee: MITSUMI ELECTRIC CO., LTD., Tokyo (JP)

(21) Appl. No.: 19/341,204

(22) Filed: Sep. 26, 2025

(30) Foreign Application Priority Data
Oct. 2, 2024 (JP) 2024-173855

(51) Int. Cl. H02J 7/00; H01M 10/0525; H01M 50/581

(52) U.S. Cl. CPC H02J 7/63; H01M 10/0525; H01M 50/581; H02J 7/40; H02J 7/82; H02J 7/933; H02J 7/975

(57) ABSTRACT

An integrated circuit for protecting a secondary battery may include: a power-supply terminal connectable with a positive terminal of the secondary battery; a ground terminal connectable with a negative terminal of the secondary battery; and a control circuit for controlling a discharge-stop circuit to stop discharging the secondary battery. In response to a power-supply voltage between the power-supply terminal and the ground terminal being at or above a first threshold voltage, which is higher than a second threshold voltage, the control circuit carries out a first operation. When a first condition in which the power-supply voltage is lower than the first threshold voltage lasts a first period of time, the control circuit starts the discharge-stop circuit. When a second condition in which the power-supply voltage is lower than the second threshold voltage lasts a second period of time, shorter than the first period, the control circuit starts the discharge-stop circuit.

### CROSS-REFERENCE TO RELATED APPLICATIONS

This application claims priority under 35 U.S.C. § 119 to Japanese Patent Application No. 2024-173855, filed on Oct. 2, 2024, the entire contents of which are incorporated herein by reference.

### BACKGROUND

### 1. Technical Field

The present disclosure relates to an integrated circuit for protecting a secondary battery, and to a battery device.

### 2. Description of the Related Art

There is a circuit for preventing over-discharge, which includes: an over-discharge detection circuit that detects when a secondary battery is over-discharged; and a circuit that stops discharging current according to the output level of the over-discharge detection circuit. When the battery's voltage falls below an over-discharge detection threshold voltage, this circuit for preventing over-discharge inverts a comparator's output level, so that a transistor that stops the discharging current is turned off.

### RELATED-ART DOCUMENT

### Patent Document

Patent Document 1: Unexamined Japanese Patent Application Publication No. H0549181

### SUMMARY

The present disclosure aims to provide an integrated circuit for protecting a secondary battery. This integrated circuit may include: a power-supply terminal connectable with a positive terminal of the secondary battery; a ground terminal connectable with a negative terminal of the secondary battery; and a control circuit configured to control a discharge-stop circuit to stop discharging of the secondary battery. In response to a power-supply voltage between the power-supply terminal and the ground terminal of the integrated circuit being greater than or equal to a first threshold voltage, the first threshold voltage being higher than a second threshold voltage, the control circuit carries out a first operation. In response to an event in which a first condition in which the power-supply voltage is lower than the first threshold voltage lasts a first period of time, the control circuit starts the discharge-stop circuit. In response to an event in which a second condition in which the power-supply voltage is lower than the second threshold voltage lasts a second period of time, the second period of time being shorter than the first period of time, the control circuit starts the discharge-stop circuit.

### BRIEF DESCRIPTION OF THE DRAWINGS

FIG. 1 shows an example structure of a system including an integrated circuit for protecting a secondary battery according to a first embodiment of the present disclosure;

FIG. 2 shows an example structure of a discharge control circuit part in the integrated circuit according to the first embodiment;

FIG. 3 explains an example of a discharge control operation by the integrated circuit according to the first embodiment;

FIG. 4 shows examples of operation waveforms exhibited during discharge control by the integrated circuit of the first embodiment;

FIG. 5 shows an example structure of a system including an integrated circuit for protecting a secondary battery according to a second embodiment of the present disclosure;

FIG. 6 shows an example structure of a discharge control circuit part in the integrated circuit according to the second embodiment;

FIG. 7 shows examples of operation waveforms exhibited during discharge control by the integrated circuit of the second embodiment;

FIG. 8 shows examples of operation waveforms exhibited during discharge control by the integrated circuit of the second embodiment;

FIG. 9 shows an example structure of a system including an integrated circuit for protecting a secondary battery according to a third embodiment of the present disclosure;

FIG. 10 shows an example structure of a discharge control circuit part in the integrated circuit according to the third embodiment;

FIG. 11 shows examples of delay circuits;

FIG. 12 shows examples of operation waveforms exhibited during discharge control by the integrated circuit of the third embodiment;

FIG. 13 shows examples of operation waveforms exhibited during discharge control by the integrated circuit of the third embodiment;

FIG. 14 shows examples of operation waveforms exhibited during discharge control by the integrated circuit of the third embodiment;

FIG. 15 shows examples of operation waveforms exhibited during discharge control by the integrated circuit of the third embodiment;

FIG. 16 shows an example structure of a system including an integrated circuit for protecting a secondary battery according to a fourth embodiment of the present disclosure;

FIG. 17 shows an example structure of a discharge control circuit part in the integrated circuit according to the fourth embodiment;

FIG. 18 shows examples of operation waveforms exhibited during discharge control by the integrated circuit of the fourth embodiment;

FIG. 19 shows examples of operation waveforms exhibited during discharge control by the integrated circuit of the fourth embodiment;

FIG. 20 shows an example structure of a system including an integrated circuit for protecting a secondary battery according to a fifth embodiment of the present disclosure;

FIG. 21 shows an example of an alternative discharge control circuit part;

FIG. 22 shows examples of relationships between battery levels and detection delay periods tVdet for varying over-discharge detection voltages Vdet; and

FIG. 23 shows examples of relationships between over-discharge detection voltages and temperatures according to the fourth embodiment.

### DETAILED DESCRIPTION

When a method of detecting over-discharge based on a single threshold voltage is used, depending on the threshold voltage's value, it may be difficult to protect a secondary battery properly from over-discharge. For example, assuming a case in which a large discharging current is produced on a temporary basis and causes a significant drop in the secondary battery's voltage, depending on the threshold voltage's value, this drop may be determined to be indicative of over-discharge, and the secondary battery's discharge may be stopped unexpectedly. Conversely, if the discharge-induced voltage drop in the secondary battery is insignificant, depending on the value of the threshold voltage, the drop may not be determined to be indicative of over-discharge, and the secondary battery may continue being discharged unexpectedly.

In view of the foregoing, the present disclosure aims to provide an integrated circuit for protecting a secondary battery, and a battery device, whereby a secondary battery can be properly protected from over-discharge.

According to the present disclosure, a secondary battery can be properly protected from over-discharge.

Embodiments of the present disclosure will be described below with reference to the accompanying drawings.

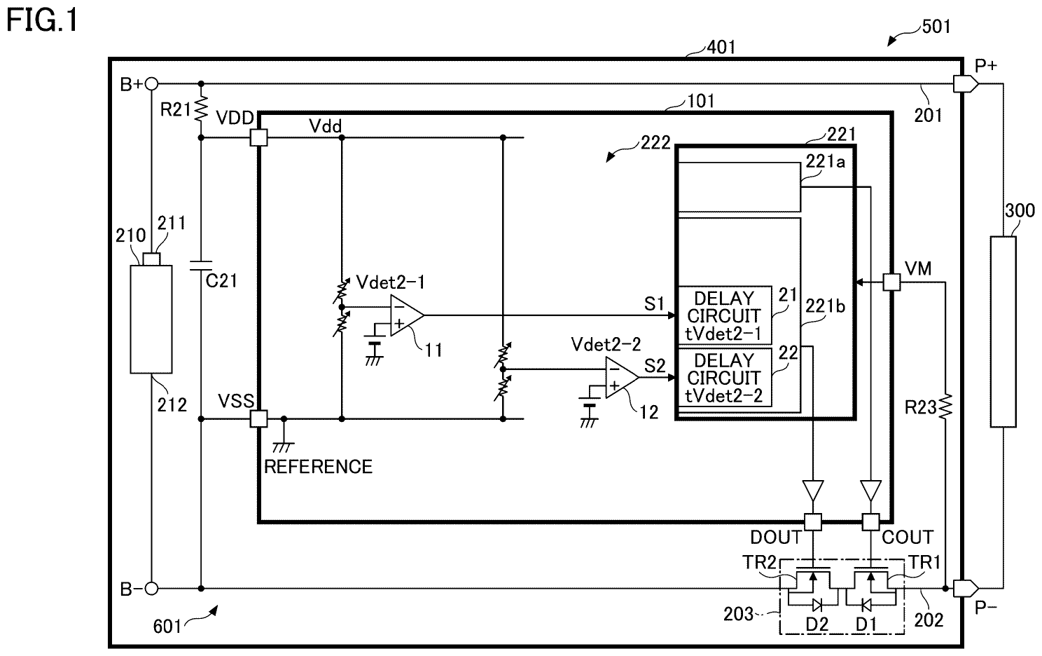

FIG. 1 shows an example structure of a system including an integrated circuit for protecting a secondary battery according to a first embodiment of the present disclosure. Referring to FIG. 1, a system 501 may include a battery device 401 and electronic equipment 300.

The electronic equipment 300 may be connected with the battery device 401. The electronic equipment 300 may be a charger for charging the battery device 401, or may be a load that operates on power fed from the battery device 401. Specific examples of such loads may include mobile telephones, smartphones, tablet devices, earphones, and so forth. The electronic equipment 300 is by no means limited to these examples.

The battery device 401 may be attached externally to the electronic equipment 300, or may be built in the electronic equipment 300. The battery device 401 may be, for example, a battery pack that can be detachably attached to the electronic equipment 300, and that can feed power to the electronic equipment 300 while the battery device 401 is connected with the electronic equipment 300. The battery device 401 and the electronic equipment 300 may be connected with each other via multiple terminals (including a positive power-supply terminal (terminal P+) and a negative power-supply terminal (terminal P−)), as shown in FIG. 1. For example, when charging the secondary battery 210, the terminal P+ and the terminal P− may be electrically connected to the charger (electronic equipment 300).

The battery device 401 may include a secondary battery 210 and a battery protection device 601.

The secondary battery 210 may be an example of a chargeable/dischargeable battery. The secondary battery 210 may feed power to the electronic equipment 300 connected to the terminals P+ and P−. The secondary battery 210 can be charged by a charger connected to the terminals P+ and P−. Specific examples of the secondary battery 210 may include a lithium ion battery, a lithium polymer battery, and so forth. The secondary battery 210 may have a positive terminal 211 and a negative terminal 212.

A battery protection device 601 may be an example of a secondary battery protection device that operates using the secondary battery 210 as its power supply. The battery protection device 601 may protect the secondary battery 210 from over-charging and other problems by controlling charging of the secondary battery 210. The battery protection device 601 may also protect the secondary battery 210 from over-discharge and the like by controlling discharging of the secondary battery 210. The battery protection device 601 may include, for example, a terminal P+, a terminal P−, a terminal B+, a terminal B−, resistance elements R21 and R23, a capacitor C21, a power-feed line 201, a ground line 202, a switch circuit 203, and a protection integrated circuit (IC) 101.

The battery protection device 601 may be, for example, a component having at least a substrate on which the protection IC 101 can be mounted.

The terminal P+ may be an example of a load positive terminal that can be connected with a power-feed line of the electronic equipment 300. The terminal P− may be an example of a load negative terminal that can be connected with a ground line of the electronic equipment 300. The terminal B+ may be an example of a battery positive terminal that can be connected with the positive terminal 211 of the secondary battery 210. The terminal B− may be an example of a battery negative terminal that can be connected with the negative terminal 212 of the secondary battery 210.

The terminal B+ and the terminal P+ may be connected via the power-feed line 201, which is a positive current path. The power-feed line 201 may be a power-supply path that connects between the terminal B+ and the terminal P+. The power-feed line 201 may function as a charge path in which current to charge the secondary battery 210 flows, and also function as a discharge path in which current to discharge the secondary battery 210 flows.

The terminal B− and the terminal P− may be connected via the ground line 202, which is a negative current path. The ground line 202 may be a power-supply path that connects between the terminal B− and the terminal P−. The ground line 202 may function as a charge path in which current to charge the secondary battery 210 flows, and also function as a discharge path in which current to discharge the secondary battery 210 flows.

The switch circuit 203 may be provided on the ground line 202 between the terminal B− and the terminal P−. The switch circuit 203 may include, for example, a charge control transistor TR1 and a discharge control transistor TR2. The charge control transistor TR1 and the discharge control transistor TR2 may be, for example, connected in series and form a series circuit, that is, the switch circuit 203, together. The charge control transistor TR1 may be a semiconductor switching element for blocking or disconnecting the charge path of the secondary battery 210. The discharge control transistor TR2 may be a semiconductor switching element for blocking or disconnecting the discharge path of the secondary battery 210.

In FIG. 1, the charge control transistor TR1 may block or disconnect the ground line 202, in which current to charge the secondary battery 210 flows. The discharge control transistor TR2 may block or disconnect the ground line 202, in which current to discharge the secondary battery 210 flows. The charge control transistor TR1 and the discharge control transistor TR2 may be switching elements for switching the ground line 202 between being conductive and being non-conductive. The charge control transistor TR1 and the discharge control transistor TR2 may be inserted in series with the ground line 202. The charge control transistor TR1 and the discharge control transistor TR2 may be, for example, N-channel metal oxide semiconductor field effect transistors (MOSFETs).

The charge control transistor TR1 may have a parasitic diode D1 between its drain and source. The forward direction of the parasitic diode D1 may be opposite to the direction in which current to charge the secondary battery 210 flows. The charge control transistor TR1 may be a switching element that is inserted in series with the ground line 202 so that the forward direction of the parasitic diode D1 and the direction in which current to discharge the secondary battery 210 flows are the same.

The discharge control transistor TR2 may have a parasitic diode D2 between its drain and source. The forward direction of the parasitic diode D2 may be opposite to the direction in which current to discharge the secondary battery 210 flows. The discharge control transistor TR2 may be a switching element that is inserted in series with the ground line 202 so that the forward direction of the parasitic diode D2 and the direction in which current to charge the secondary battery 210 flows are the same.

The protection IC 101 may be an example of an integrated circuit for protecting the secondary battery 210. The protection IC 101 may operate using the secondary battery 210 as its power supply.

The protection IC 101 may protect the secondary battery 210 from over-discharge and the like by controlling the switch circuit 203. For example, if the detection circuit 222 detects abnormal charging (e.g., over-charging, excessive current flow in the charging direction (over-charging current), etc.), the protection IC 101 may turn off the charge control transistor TR1 to protect the secondary battery 210 from the abnormal charging. On the other hand, if the detection circuit 222 detects abnormal discharge (e.g., over-discharge, excessive current flow in the discharging direction (over-discharging current), etc.), the protection IC 101 may turn off the discharge control transistor TR2 to protect the secondary battery 210 from the abnormal discharge.

The protection IC 101 may include, for example, a charge control terminal (terminal COUT), a discharge control terminal (terminal DOUT), a detection terminal (terminal VM), a power supply terminal (terminal VDD), and a ground terminal (terminal VSS). These terminals may be, for example, outside terminals for connecting the inner circuitry of the protection IC 101 to the outside of the protection IC 101.

The terminal COUT may be connected to the gate (control electrode) of the charge control transistor TR1 and output a signal to turn the charge control transistor TR1 on or off. The terminal DOUT may be connected to the gate (control electrode) of the discharge control transistor TR2 and output a signal to turn the discharge control transistor TR2 on or off.

The terminal VM may be an example of a monitoring terminal that is connected to the terminal P− to monitor the potential of the terminal P−. The terminal VM may be used when, for example, the control circuit 221 in the protection IC 101 monitors whether the electronic equipment 300 or a charger is connected. The terminal VM may be connected to the ground line 202 between the switch circuit 203 and the terminal P− via the resistance element R23. The terminal VM may be electrically connected to the ground line 202 on the opposite side of the secondary battery 210 with respect to the switch circuit 203.

The terminal VM may be used to detect an over-charging current or an over-discharging current that flows to or from the secondary battery 210.

The terminal VDD may be a power-supply terminal of the protection IC 101, connected to the positive terminal 211 and the power-feed line 201 of the secondary battery 210 via the resistance element R21. The terminal VSS may be a ground terminal of the protection IC 101, connected to the negative terminal 212 of the secondary battery 210. The capacitor C21 may be connected between the terminal VDD and the terminal VSS. The terminal VSS may be connected to the ground line 202 between the switch circuit 203 and the negative terminal 212. In this particular example, the terminal VSS is connected to the ground line 202 between the discharge control transistor TR2 and the negative terminal 212.

The protection IC 101 may include a detection circuit 222 and a control circuit 221.

The control circuit 221 may include a charging control circuit 221a that controls charging of the secondary battery 210. If the detection circuit 222 keeps detecting over-charge of the secondary battery 210 for a predetermined period of time for delay of detection (hereinafter simply “detection delay period”), or tVdet1, the charging control circuit 221a may output a signal (e.g., a low-level gate control signal) that switches the charge control transistor TR1 from on to off, from the terminal COUT. If the detection circuit 222 keeps detecting an over-charging current for the secondary battery 210 for a predetermined detection delay period tVdet4, the charging control circuit 221a may output a signal (e.g., a low-level gate control signal) that switches the charge control transistor TR1 from on to off, from the terminal COUT.

By turning off the charge control transistor TR1, the control circuit 221 can prevent or substantially prevent a current flowing in the direction to charge the secondary battery 210 from flowing into the ground line 202. This stops charging of the secondary battery 210, thus allowing the protection IC 101 to protect the secondary battery 210 from over-charge or an over-charging current.

The control circuit 221 may include a discharge control circuit 221b that controls discharging of the secondary battery 210. If the detection circuit 222 keeps detecting over-discharge of the secondary battery 210 for a predetermined detection delay period tVdet2, the discharge control circuit 221b may output a signal (e.g., a low-level gate control signal) that switches the discharge control transistor TR2 from on to off, from the terminal DOUT. If the detection circuit 222 keeps detecting an over-discharging current for the secondary battery 210 for a predetermined detection delay period tVdet3, the discharge control circuit 221b may output a signal (e.g., a low-level gate control signal) that switches the discharge control transistor TR2 from on to off, from the terminal DOUT.

By turning off the discharge control transistor TR2, the control circuit 221 can prevent or substantially prevent a current flowing in the direction to discharge the secondary battery 210 from flowing into the ground line 202. This stops discharging of the secondary battery 210, thus allowing the protection IC 101 to protect the secondary battery 210 from over-discharge or an over-discharging current.

The detection circuit 222 may include an over-discharge detection circuit. The over-discharge detection circuit may detect over-discharge of the secondary battery 210 by monitoring the power-supply voltage Vdd between the terminal VDD and the terminal VSS. The over-discharge detection circuit may compare the power-supply voltage Vdd with an over-discharge detection voltage Vdet2. If the power-supply voltage Vdd is lower than the over-discharge detection voltage Vdet2, the over-discharge detection circuit may generate an over-discharge detection signal, which indicates that over-discharge of the secondary battery 210 has been detected.

In the example illustrated in FIG. 1, the over-discharge detection circuit includes a first over-discharge detection circuit 11 and a second over-discharge detection circuit 12. The first over-discharge detection circuit 11 may compare the power-supply voltage Vdd with a first over-discharge detection voltage Vdet2-1, which is determined in advance. If the power-supply voltage Vdd is lower than Vdet2-1, the first over-discharge detection circuit 11 may generate a first over-discharge detection signal S1, which indicates that over-discharge of the secondary battery 210 has been detected. The second over-discharge detection circuit 12 may compare the power-supply voltage Vdd with a second over-discharge detection voltage Vdet2-2, which is determined in advance. If the power-supply voltage Vdd is lower than Vdet2-2, the second over-discharge detection circuit 12 may generate a second over-discharge detection signal S2, which indicates that over-discharge of the secondary battery 210 has been detected.

Vdet2-1 may be set higher than Vdet2-2. Vdet2-1 may be an example of a first threshold voltage. Vdet2-2 may be an example of a second threshold voltage, which is lower than the first threshold voltage. Vdet2-1 and Vdet2-2 may be both set in advance to voltage values that are determined by the respective trimming conditions of multiple trimming elements (not shown). The trimming elements may be fuse elements that can be cut by laser emission from outside the protection IC 101.

The control circuit 221 may include a discharge control circuit 221b that can control the discharge control transistor TR2, which stops discharging of the secondary battery 210. The discharge control transistor TR2 may be a discharge-stop circuit that is configured to stop discharging of the secondary battery 210.

The discharge control circuit 221b may carry out a first operation when the power-supply voltage Vdd is higher than or equal to Vdet2-1. The first operation may be, for example, an operation for allowing discharging of the secondary battery 210. To be more specific, in the first operation, a signal that turns on the discharge control transistor TR2 may be output from the terminal DOUT. If no first over-discharge detection signal S1 is detected, the discharge control circuit 221b may determine that the power-supply voltage Vdd is higher than or equal to Vdet2-1.

In the event a first condition A1, in which the power-supply voltage Vdd is lower than Vdet2-1, lasts a first period of time (hereinafter simply “first period”), the discharge control circuit 221b may control the discharge control transistor TR2 to stop discharging of the secondary battery 210. For example, if the delay circuit 21 keeps detecting the first over-discharge detection signal S1 for a predetermined delay period tVdet2-1, the discharge control circuit 221b may determine that the first condition A1 holds. The detection delay period tVdet2-1 is an example of a first period. In the event the first condition A1 holds, the discharge control circuit 221b may output a signal for turning off the discharge control transistor TR2, from the terminal DOUT, to stop discharging of the secondary battery 210.

When a second condition A2, in which the power-supply voltage Vdd is lower than Vdet2-2 lasts a second period of time, which is shorter than the first period, the discharge control circuit 221b may control the discharge control transistor TR2 to stop discharging of the secondary battery 210. For example, if the delay circuit 22 keeps detecting the second over-discharge detection signal S2 for a predetermined detection delay period tVdet2-2, the discharge control circuit 221b may determine that the second condition A2 holds. The detection delay period tVdet2-2 may be an example of a second period. When the second condition A2 holds, the discharge control circuit 221b may output a signal for turning off the discharge control transistor TR2, from the terminal DOUT, to stop discharging of the secondary battery 210.

Thus, according to the protection IC 101 of the first embodiment, when the state in which the power-supply voltage Vdd is lower than Vdet2-1 lasts the detection delay period tVdet2-1, discharging of the secondary battery 210 may be stopped to protect the secondary battery 210 from over-discharge. On the other hand, if the state in which the power-supply voltage Vdd is lower than Vdet2-2 (which is lower than Vdet2-1) lasts the detection delay period tVdet2-2 (which is shorter than tVdet2-1), discharging of the secondary battery 210 may be stopped to protect the secondary battery 210 from over-discharge. Therefore, even when discharging causes only a slight drop in voltage in the secondary battery 210, discharging of the secondary battery 210 may be stopped if the state in which the power-supply voltage Vdd is lower than Vdet2-1 lasts the detection delay period tVdet2-1, so that the secondary battery 210 can be properly protected from over-discharge. On the other hand, if discharging causes a significant voltage drop in the secondary battery 210, discharging of the secondary battery 210 may be promptly stopped if the state in which the power-supply voltage Vdd is lower than Vdet2-2 (which is lower than Vdet2-1) lasts tVdet2-2, which is shorter than tVdet2-1, so that the secondary battery 210 can be properly protected from over-discharge.

Thus, the protection IC 101 of the first embodiment may detect over-discharge using multiple threshold voltages (e.g., Vdet2-1 and Vdet2-2) and provide multiple delay periods of time (or simply “delay period(s),” examples including tVdet2-1 and tVdet2-2) that correspond to these threshold voltages. Vdet2-1 may be set higher than Vdet2-2, and tVdet2-1, which corresponds to Vdet2-1, may be set longer than tVdet2-2, which corresponds to Vdet2-2.

In the event a low discharging current (load current) is flowing or the battery level is sufficient, the voltage of the secondary battery 210 may drop only slightly, so that it is possible, for example, to set the threshold voltage high and the delay period long, as long as no anomalies (breakdown, smoke, heat, etc.) occur in the secondary battery 210 or in the electronic equipment 300. Therefore, if a low discharging current (load current) is flowing or the battery level is sufficient, setting a high threshold voltage and a long delay period may have a relatively small impact on over-discharge detection and stopping of discharging based thereon. On the other hand, if a high discharging current (load current) is flowing or the battery level is low, the voltage in the secondary battery 210 may undergo a significant drop, and so it is preferable to set a low threshold voltage and a short delay period. In the event the secondary battery 210 undergoes a significant voltage drop, discharging of the secondary battery 210 can be stopped quickly to protect the secondary battery 210 from over-discharge.

As described above, the protection IC 101 and the battery device 401 of the first embodiment may use multiple different threshold voltages and multiple different delay periods to carry out an operation for stopping discharging when over-discharge is detected, thereby properly protecting the secondary battery 210 from over-discharge.

In particular, in the event a lithium ion battery with a silicon negative terminal is used for the secondary battery 210, the protection IC 101 and the battery device 401 according to the first embodiment can properly protect the lithium ion battery from over-discharge by using multiple different threshold voltages and multiple different delay periods. Lithium ion batteries with silicon negative terminals may have an advantage of having higher energy density than lithium ion batteries with graphite negative terminals, but may also have a disadvantage of being more susceptible to degradation in over-discharging conditions. Assuming that the over-discharge detection voltage Vdet2 is set high to take a measure against such degradation, the protection IC 101 may then detect over-discharge with increased sensitivity, which may lead to a situation in which discharging is stopped too much or too often and in which the electronic equipment 300 therefore cannot be fed power in a stable manner. The protection IC 101 and the battery device 401 according to the first embodiment may detect over-discharge and stop the discharging current based on multiple different sensitivity levels, thereby ensuring the convenience of power feeding to the electronic equipment 300 and preventing or substantially preventing lithium ion batteries from deteriorating.

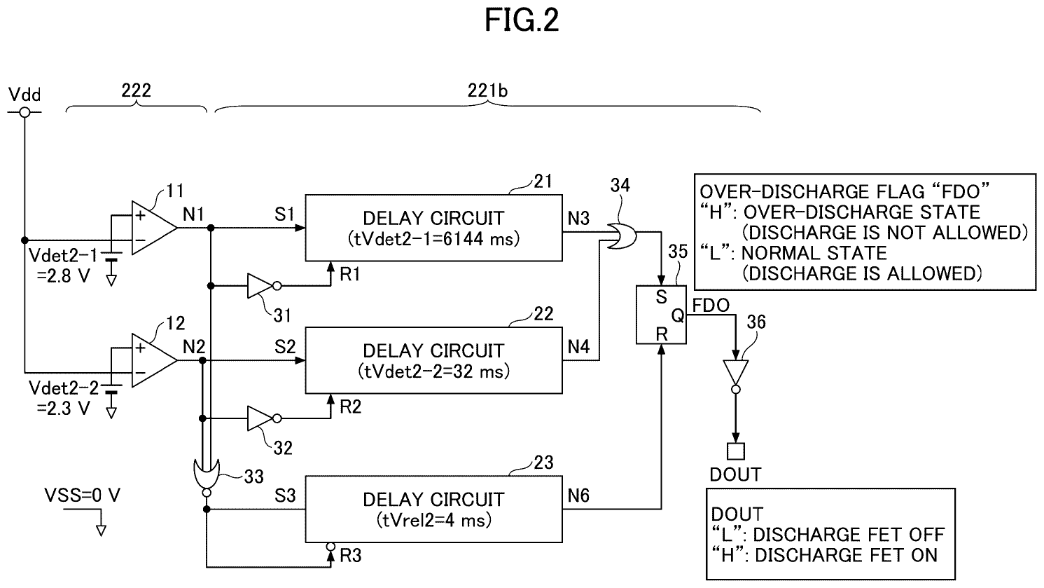

FIG. 2 is a circuit diagram showing an example of a discharge control circuit part in the integrated circuit according to the first embodiment. The detection circuit 222 may include a first over-discharge detection circuit 11 and a second over-discharge detection circuit 12.

The first over-discharge detection circuit 11 may have a comparator that compares the power-supply voltage Vdd with the predetermined first over-discharge detection voltage Vdet2-1, and output the first over-discharge detection signal S1 from a node N1. When the power-supply voltage Vdd is greater than or equal to the first over-discharge detection voltage Vdet2-1, the first over-discharge detection circuit 11 may set the first over-discharge detection signal S1 to a low level. When the power-supply voltage Vdd is lower than the first over-discharge detection voltage Vdet2-1, the first over-discharge detection circuit 11 may set the first over-discharge detection signal S1 to a high level. The second over-discharge detection circuit 12 may have a comparator that compares the power-supply voltage Vdd with the predetermined second over-discharge detection voltage Vdet2-2, and output the second over-discharge detection signal S2 from a node N2. When the power-supply voltage Vdd is greater than or equal to the second over-discharge detection voltage Vdet2-2, the second over-discharge detection circuit 12 may set the second over-discharge detection signal S2 to the low level. When the power-supply voltage Vdd is lower than the second over-discharge detection voltage Vdet2-2, the second over-discharge detection circuit 12 may set the second over-discharge detection signal S2 to the high level.

The discharge control circuit 221b may include delay circuits 21, 22, and 23, NOT gates 31 and 32, a NOR gate 33, an OR gate 34, a latch circuit 35, and a NOT gate 36. The NOT gate 31 may generate a reset signal R1 by inverting the level of the first over-discharge detection signal S1. The NOT gate 32 may generate a reset signal R2 by inverting the level of the second over-discharge detection signal S2.

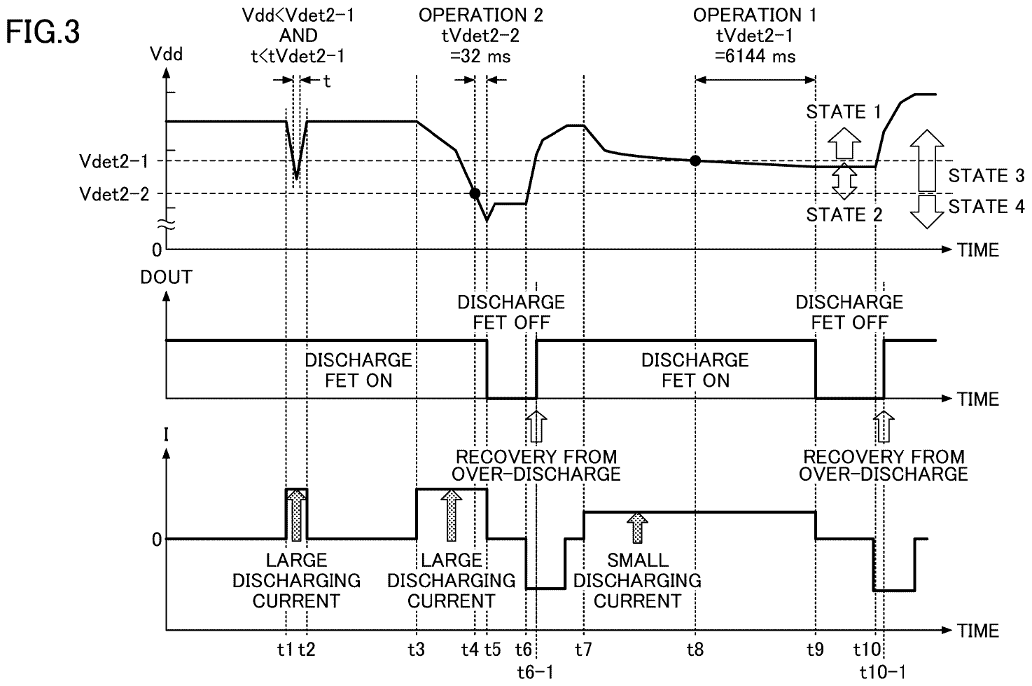

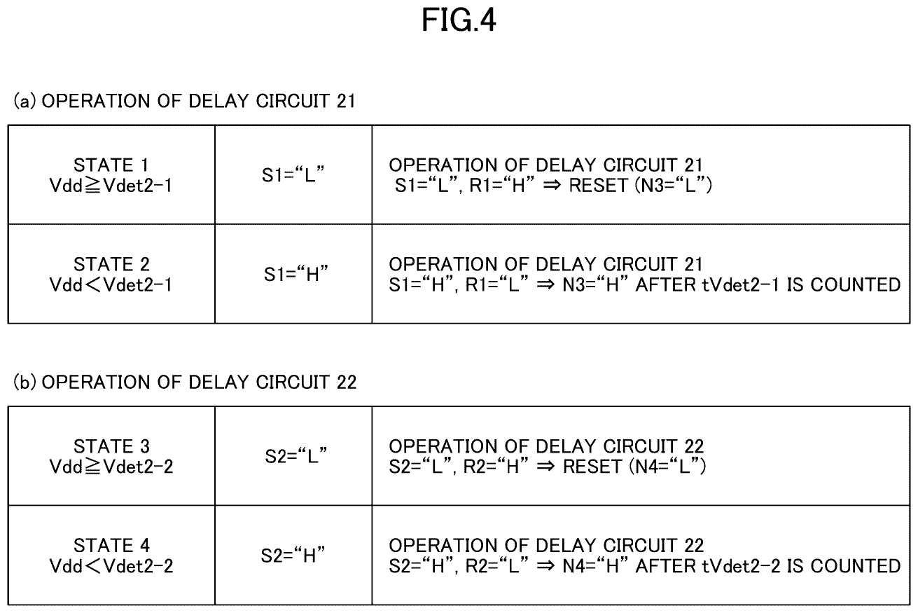

When the first over-discharge detection signal S1 is set to the low level and the reset signal R1 is set to the high level, the delay circuit 21 may set the node N3 to the low level (see, for example, t8 in FIG. 3 and the state 1 in FIG. 4). Referring to FIG. 2, when the first over-discharge detection signal S1 switches from the low level to the high level and the reset signal R1 switches from the high level to the low level, the delay circuit 21 may begin counting. After the counting passes the end of the predetermined detection delay period tVdet2-1, the delay circuit 21 may switch the node N3 from the low level to the high level (see, for example, t9 in FIG. 3 and the state 2 in FIG. 4).

In FIG. 2, when the node N3 switches from the low level to the high level, the output node of the OR gate 34 (the set terminal S of the latch circuit 35) may change to the high level. As a result of this, an over-discharge flag FDO, which is output from an output terminal Q of the latch circuit 35, may switch from the low level to the high level, so that the NOT gate 36 may switch its terminal DOUT from the high level to the low level. By so doing, discharging of the secondary battery 210 may be stopped by the discharge control transistor TR2 (see, for example, the operation 1 in FIG. 3).

Referring to FIG. 2, when the second over-discharge detection signal S2 is set to the low level and the reset signal R2 is set to the high level, the delay circuit 22 may set a node N4 to the low level (see, for example, t4 in FIG. 3 and the state 3 in FIG. 4). Referring to FIG. 2, when the second over-discharge detection signal S2 switches from the low level to the high level and the reset signal R2 switches from the high level to the low level, the delay circuit 22 may begin counting. After the counting passes the end of the predetermined detection delay period tVdet2-2, the delay circuit 22 may switch the node N4 from the low level to the high level (see, for example, t5 in FIG. 3 and the state 4 in FIG. 4).

In FIG. 2, when the node N4 switches from the low level to the high level, the output node of the OR gate 34 (the set terminal S of the latch circuit 35) may change to the high level. As a result of this, the over-discharge flag FDO, which is output from the output terminal Q of the latch circuit 35, switches from the low level to the high level, so that the NOT gate 36 may switch its terminal DOUT from the high level to the low level. By so doing, discharging of the secondary battery 210 may be stopped by the discharge control transistor TR2 (see, for example, the operation 2 in FIG. 3).

In FIG. 2, the NOR gate 33 outputs a signal S3, which is the logical NOR of the first over-discharge detection signal S1 and the second over-discharge detection signal S2. A reset signal R3 may be obtained by inverting the level of the signal S3.

When the signal S3 is set to the low level and the reset signal R3 is set to the high level, the delay circuit 23 may set the node N6 to the low level (see, for example, t6 and t10 in FIG. 3). Note that the signal S3 may be set to the low level and the reset signal R3 may be set to the high level when, for example, the node N1 or the node N2 is set to the low level and the power-supply voltage Vdd is lower than Vdet2-1 (for example, 2.8 V). When the signal S3 switches from the low level to the high level and the reset signal R3 may switch from the high level to the low level, the delay circuit 23 may begin counting. The counting may begin when the node N1 and the node N2 are set to the low level and the power-supply voltage Vdd is higher than or equal to Vdet2-1 (e.g., 2.8 V). After the counting passes the end of the predetermined detection delay period tVrel 2, the delay circuit 23 may switch a node N6 (a reset terminal R of the latch circuit 35) from the low level to the high level. As a result of this, the over-discharge flag FDO, which is output from the output terminal Q of the latch circuit 35, may switch from the high level to the low level, so that the NOT gate 36 may switch its terminal DOUT from the low level to the high level (see, for example, t6-1 and t10-1 in FIG. 3). By so doing, the secondary battery 210 may recover from an over-discharge state, and the discharge control transistor TR2 may be turned on, allowing discharging of the secondary battery 210 (see, for example, recovery from over-discharge in FIG. 3).

Note that, although the power-supply voltage Vdd may become smaller than the over-discharge detection voltage Vdet2-1, if the time the power-supply voltage Vdd is lower than the over-discharge detection voltage Vdet2-1 lasts shorter than the detection delay period tVdet2-1, the discharge control circuit 221b need not turn off the discharge control transistor TR2 (see, for example, t1 to t2 in FIG. 3). Similarly, although the power-supply voltage Vdd may become lower than the over-discharge detection voltage Vdet2-2, if the time the power-supply voltage Vdd is lower than the over-discharge detection voltage Vdet2-2 lasts shorter than the detection delay period tVdet2-2, the discharge control circuit 221b need not turn off the discharge control transistor TR2. As a result of this, noise and other factors can be prevented or substantially prevented from turning off the discharge control transistor TR2.

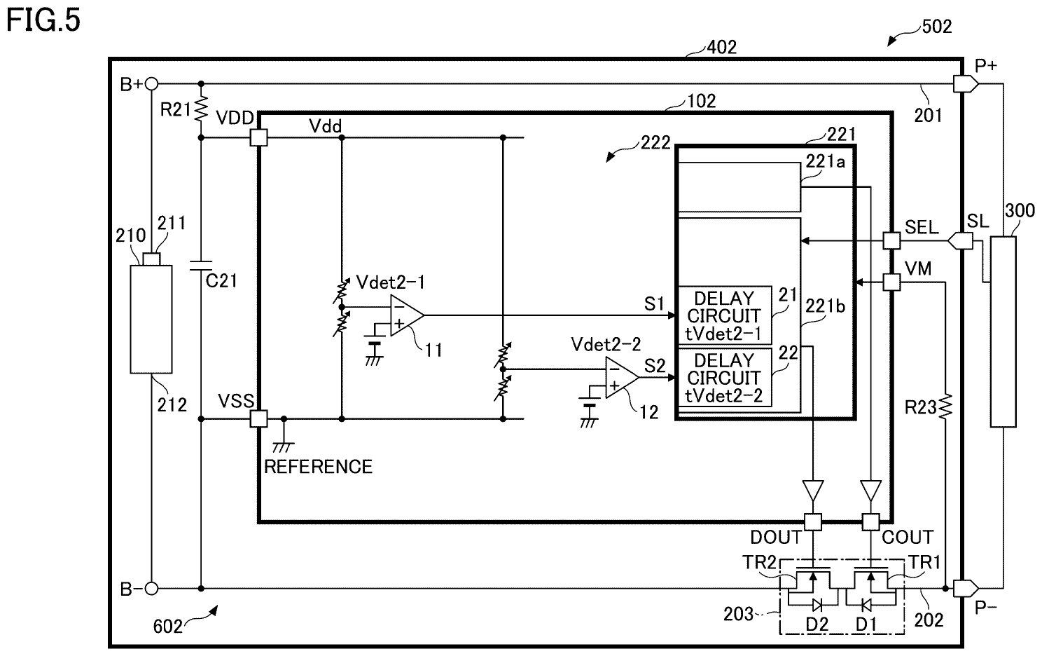

FIG. 5 is a circuit diagram showing an example system including an integrated circuit for protecting a secondary battery according to a second embodiment of the present disclosure. The following second embodiment incorporates the description given thus far by reference, so that parts, functions, and effects of the second embodiment that are the same or substantially the same as those of the first embodiment will not be described again. The second embodiment is different from the first embodiment in that, for example, it additionally includes an input terminal SL and an input terminal SEL.

In FIG. 5, a system 502 may include a battery device 402 and electronic equipment 300. The battery device 402 may include a secondary battery 210 and a battery protection device 602. The battery protection device 602 may be, for example, a component having at least a substrate on which a protection IC 102 can be mounted. The battery device 402 may include an input terminal SL. The protection IC 102 may include an input terminal SEL, which can be connected with the input terminal SL.

The input terminal SL and the input terminal SEL may be input terminals for receiving information from outside equipment such as the electronic equipment 300. While the input terminal SEL receives predetermined first information SI1 from outside equipment, the discharge control circuit 221b may control the discharge control transistor TR2 based on the first condition A1. While the input terminal SEL receives second information SI2, which is different from the first information SI1, from outside equipment, the discharge control circuit 221b may control the discharge control transistor TR2 based on the second condition A2. Thus, when varying information is input from outside equipment to the input terminal SEL, the discharge control circuit 221b can switch the over-discharge detection voltage Vdet2 and the detection delay period tVdet2 to values that correspond to the varying information.

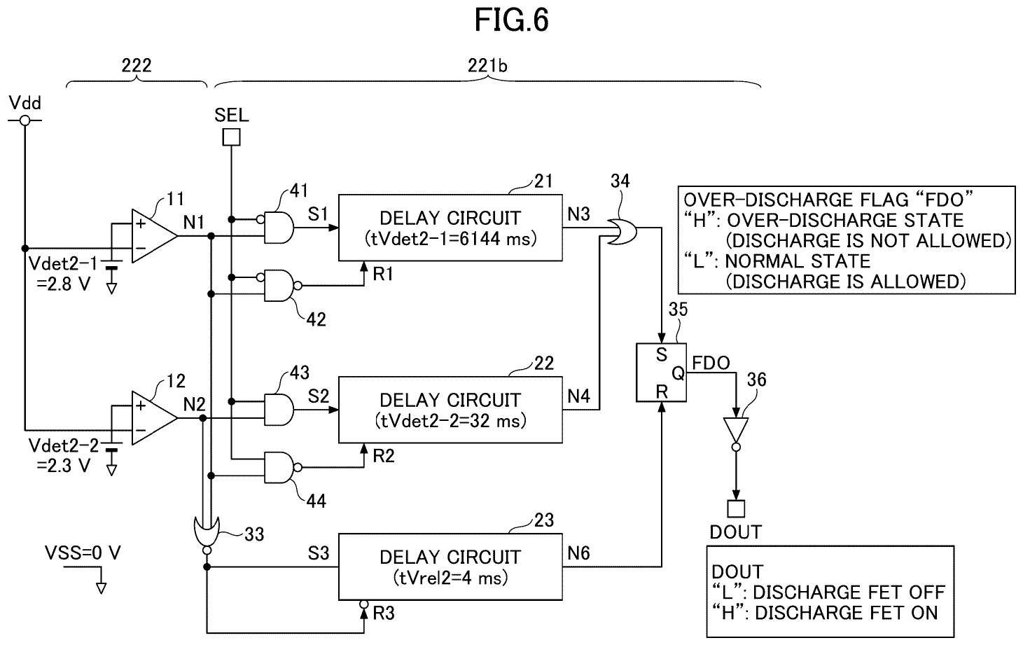

FIG. 6 is a circuit diagram showing an example of a discharge control circuit part in the integrated circuit according to the second embodiment. The detection circuit 222 may include a first over-discharge detection circuit 11 and a second over-discharge detection circuit 12. The discharge control circuit 221b may include delay circuits 21, 22, and 23, logic gates 41, 42, 43, and 44, a NOR gate 33, an OR gate 34, a latch circuit 35, and a NOT gate 36.

The logic gate 41 may output a first over-discharge detection signal S1, which is the logical AND of: the level obtained by inverting the level of information input from the input terminal SEL; and the level at the node N1. The logic gate 42 may output a reset signal R1, which is the logical NAND of: the level obtained by inverting the level of the information input from the input terminal SEL; and the level at the node N1. The logic gate 43 may output a second over-discharge detection signal S2, which is the logical AND of the level of the information input from the input terminal SEL and the level at the node N2. The logic gate 44 may output a reset signal R2, which is the logical NAND of the level of the information input from the input terminal SEL and the level at the node N2. The delay circuits 21, 22, and 23 may operate as described hereinabove.

The first information SI1 or the second information SI2 may be input from outside equipment to the input terminal SEL. For example, the first information SI1 may indicate that the electronic equipment 300 is in sleep mode, and the second information SI2 may indicate that the electronic equipment 300 is in active mode. Sleep mode may refer to a state in which the electronic equipment 300 consumes less power than when it is in active mode.

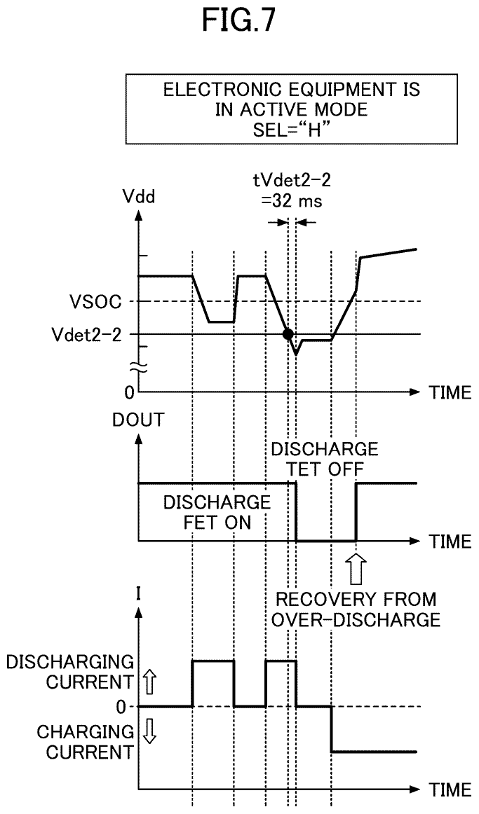

In active mode, the discharge current (load current) may be relatively large, so that the secondary battery 210 may undergo a large voltage drop. To address this issue, it is preferable to set a low threshold voltage and a short delay period. Accordingly, while high-level second information SI2, which indicates that the electronic equipment 300 is in active mode, is input to the input terminal SEL, the discharge control circuit 221b may control the discharge control transistor TR2 based on the second condition A2. In this case, as in the first embodiment, if the state in which the power-supply voltage Vdd is lower than Vdet2-2 (which is lower than Vdet2-1) lasts a detection delay period tVdet2-2 (which is shorter than tVdet2-1), the delay circuit 221b may stop discharging the secondary battery 210 (see, for example, FIG. 7). This can quickly stop discharging of the secondary battery 210, ensuring proper protection of the secondary battery 210 from over-discharge.

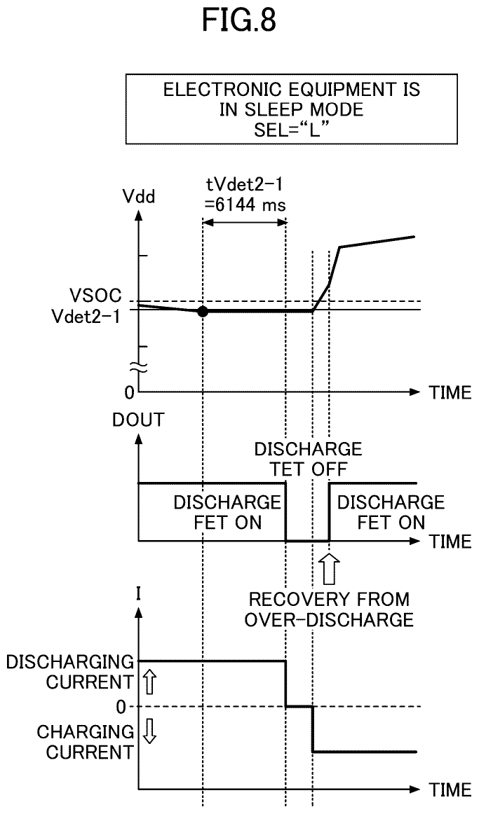

On the other hand, in sleep mode, the discharge current (load current) may be relatively small, so that the secondary battery 210 may undergo a small voltage drop. This may allow the threshold voltage to be set high and the delay period to be set long, as long as no anomalies (destruction, smoke, heat, etc.) occur in the secondary battery 210 or in the electronic equipment 300. Accordingly, while low-level first information SI1, which indicates that the electronic equipment 300 is in sleep mode, is input to the input terminal SEL, the discharge control circuit 221b may control the discharge control transistor TR2 based on the first condition A1. In this case, as in the first embodiment, if the state in which the power-supply voltage Vdd is lower than Vdet2-1 lasts a detection delay period tVdet2-1, the delay circuit 221b may stop discharging the secondary battery 210 (see, for example, FIG. 8). This may ensure proper protection of the secondary battery 210 from over-discharge.

The first information SI1 and the second information SI2 need not be information about the operation of the electronic equipment 300, such as information that indicates sleep mode and active mode. For example, information about battery level such as the state of charge (SOC) of the secondary battery 210 may be used as well. Information about battery level such as SOC may be calculated by a battery level meter IC, the electronic equipment 300, and so forth. For example, the first information SI1 may indicate that the SOC of the secondary battery 210 corresponds to a first SOC, and the second information SI2 may indicate that the SOC of the secondary battery 210 corresponds to a second SOC, which is lower than the first SOC. For example, assuming that a threshold VSOC of 10% is applied, the first information SI1 may then indicate a state in which the SOC in question is between 0% and 10%, inclusive (and that the state therefore corresponds to a “first SOC”), and the second information SI2 may indicate a state in which the SOC in question is between 10% and 100%, inclusive (and that the state therefore corresponds to a “second SOC”).

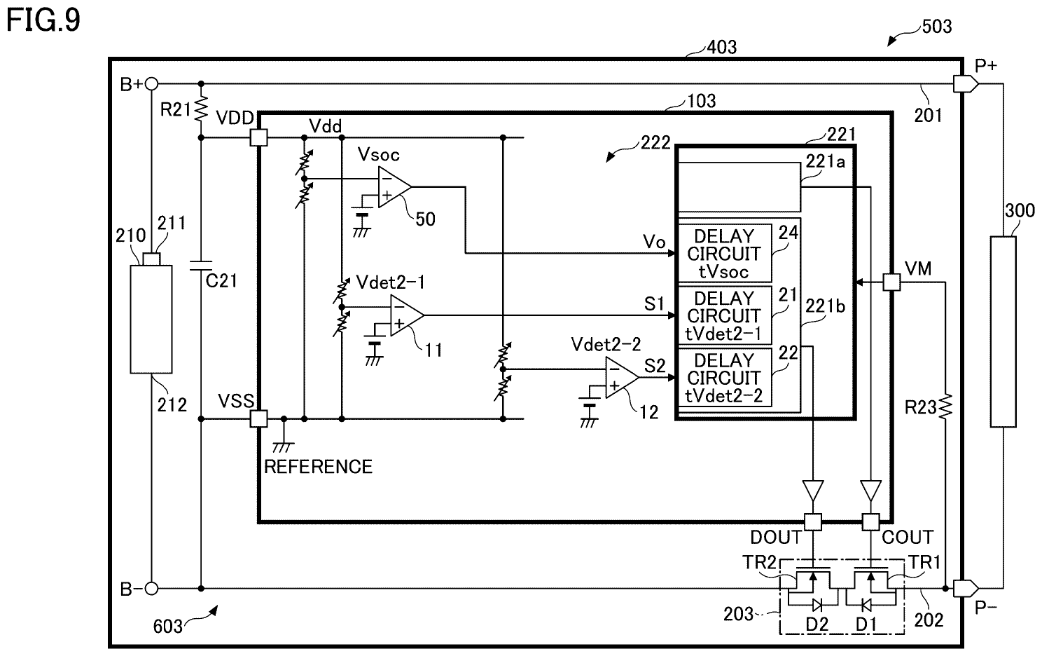

FIG. 9 is a circuit diagram showing an example system including an integrated circuit for protecting a secondary battery according to a third embodiment of the present disclosure. The following third embodiment incorporates the description given thus far by reference, so that parts, functions, and effects of the third embodiment that are the same or substantially the same as those of the above embodiments will not be described again. The third embodiment is different from the first embodiment in that, for example, it additionally includes a low-voltage detection circuit 50.

In FIG. 9, a system 503 may include a battery device 403 and electronic equipment 300. The battery device 403 may include a secondary battery 210 and a battery protection device 603. The battery protection device 603 may be, for example, a component having at least a substrate on which a protection IC 103 can be mounted.

Triggered when the power-supply voltage Vdd drops to or below the threshold voltage Vsoc (which is higher than the over-discharge detection voltage Vdet2), the protection IC 103 may select the specifics of over-discharge detection (e.g., the over-discharge detection voltage Vdet2 and the detection delay period tVdet2) based on information detected inside the protection IC 103. For example, when an improper power-supply voltage Vdd that is lower than or equal to the over-discharge detection voltage Vdet2 is detected, the discharge control circuit 221b may change and set the specifics of over-discharge detection (e.g., the over-discharge detection voltage Vdet2 and the detection delay period tVdet2) based on the state of the power-supply voltage Vdd prior to the timing the improper voltage Vdd was detected. This use of information about the power-supply voltage Vdd before over-discharge is detected may allow the discharge control circuit 221b to select the specifics of over-discharge detection more appropriately.

The low-voltage detection circuit 50 may compare the power-supply voltage Vdd with a predetermined threshold voltage Vsoc. If the power-supply voltage Vdd is lower than the threshold voltage Vsoc, the low-voltage detection circuit 50 may generate a low-voltage detection signal Vo, which indicates that a power-supply voltage Vdd that is lower than or equal to a predetermined voltage has been detected. The threshold voltage Vsoc may be set higher than Vdet2-1. The threshold voltage Vsoc may be an example of a third threshold voltage. Varying SOCs and battery voltages may be associated with each other in advance, and, in accordance with their relationships, the threshold voltage Vsoc may be set to a predetermined voltage in advance, based on the trimming conditions of multiple trimming elements (not shown).

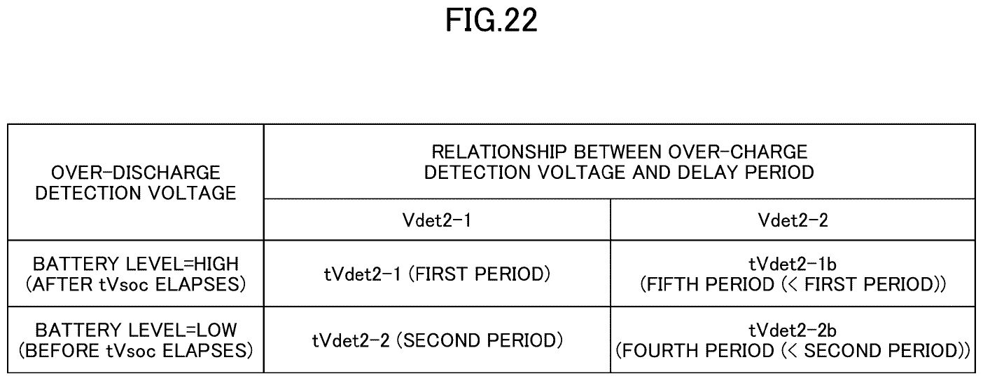

FIG. 22 shows examples of relationships between battery levels and detection delay periods tVdet2 for varying over-discharge detection voltages Vdet2. After the power-supply voltage Vdd drops to or below the threshold voltage Vsoc and then a delay period tVsoc elapses, the discharge control circuit 221b may determine whether the power-supply voltage Vdd has fallen below Vdet2-2. The delay period tVsoc may be an example of a third period. If the power-supply voltage Vdd has fallen below Vdet2-2, the discharge control circuit 221b may start the discharge control transistor TR2 after a detection delay period tVdet2-2b, which is shorter than the detection delay period tVdet2-2, elapses. tVdet2-2b may be an example of a fourth period, which is shorter than the second period.

After the power-supply voltage Vdd drops to or below the threshold voltage Vsoc and then the delay period tVsoc elapses, the discharge control circuit 221b may determine whether the power-supply voltage Vdd has fallen below Vdet2-1 in conjunction with whether the power-supply voltage Vdd is at or above Vdet2-2. If the power-supply voltage Vdd has fallen below Vdet2-1 in conjunction with being at or above Vdet2-2, the discharge control circuit 221b may start the discharge control transistor TR2 after a detection delay period tVdet2-1b, which is shorter than the detection delay period tVdet2-1, elapses. tVdet2-2b may be an example of a fifth period, which is shorter than the first period described above.

In the event the power-supply voltage Vdd drops to or below the threshold voltage Vsoc, the discharge control circuit 221b may determine, within the delay period tVsoc, whether the power-supply voltage Vdd has fallen below Vdet2-2. The delay period tVsoc may be an example of the third period. If the power-supply voltage Vdd has fallen below Vdet2-2, the discharge control circuit 221b may start the discharge control transistor TR2 after the detection delay period tVdet2-2 (second period) elapses. When a high-level first over-discharge detection signal S1 or a high-level second over-discharge detection signal S2 is detected, the pulse generation circuit 16 may generate a one-shot pulse Φ having a predetermined pulse width.

After the power-supply voltage Vdd drops to or below the threshold voltage Vsoc, the discharge control circuit 221b may determine, within the delay period tVsoc, whether the power-supply voltage Vdd has fallen below Vdet2-1 in conjunction with whether the power-supply voltage Vdd is at or above Vdet2-2. If the power-supply voltage Vdd has fallen below Vdet2-1 in conjunction with being at or above Vdet2-2, the discharge control circuit 221b may start the discharge control transistor TR2 when the detection delay period tVdet2-1 (first period) elapses.

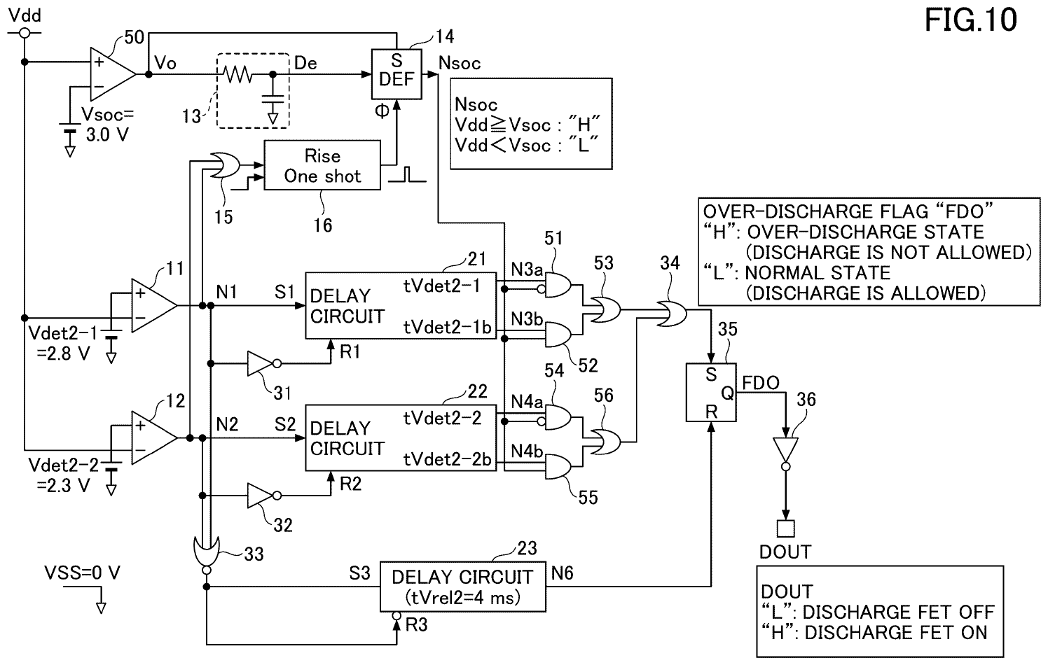

FIG. 10 shows an example circuit structure of a discharge control circuit part in the integrated circuit according to the third embodiment. The low-voltage detection circuit 50 may have a comparator that compares the power-supply voltage Vdd with a predetermined threshold voltage Vsoc and output a low-voltage detection signal Vo. If the power-supply voltage Vdd is greater than or equal to the threshold voltage Vsoc, the low-voltage detection circuit 50 may set the low-voltage detection signal Vo to a high level. On the other hand, if the power-supply voltage Vdd is lower than the threshold voltage Vsoc, the low-voltage detection circuit 50 may set the low-voltage detection signal Vo to a low level.

The OR gate 15 may output a signal representing the logical OR of the first over-discharge detection signal S1 and the second over-discharge detection signal S2. The pulse generation circuit 16 may generate a one-shot pulse Φ of a predetermined pulse width when a high-level first over-discharge detection signal S1 or a high-level second over-discharge detection signal S2 is detected.

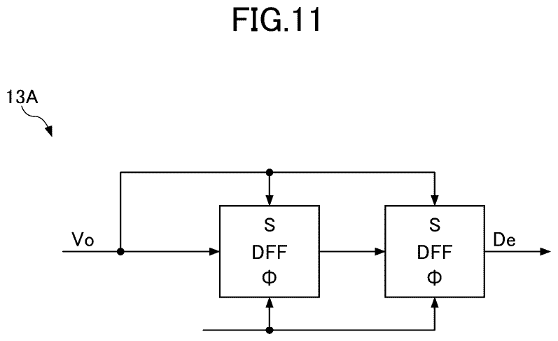

After a power-supply voltage Vdd that is lower than the threshold voltage Vsoc is detected and then a predetermined delay period tVsoc elapses, the delay circuit 13 may switch a delay signal De from a high level to a low level. The delay circuit 13 may generate the delay period tVsoc. As shown in FIG. 11, the delay circuit 13 may be a shift register 13A in which flip-flops are connected in series.

In FIG. 10, the delay signal De may be input to a data input terminal of a flip-flop 14. The flip-flop 14 may have: a set terminal S where a low-voltage detection signal Vo may be input; and a clock input terminal where a one-shot pulse Φ may be input. The flip-flop 14 may set the delay signal De's level at the timing a one-shot pulse Φ is input to a low-voltage flag Nsoc's level. When the power-supply voltage Vdd is greater than or equal to the threshold voltage Vsoc, the low-voltage flag Nsoc may be set to a high level. On the other hand, when the power-supply voltage Vdd is lower than the threshold voltage Vsoc, the low-voltage flag Nsoc may be set to a low level. The delay circuits 21, 22, and 23 operate as described earlier.

When the first over-discharge detection signal S1 is set to the low level and the reset signal R1 is set to the high level, the delay circuit 21 may set the nodes N3a and N3b to the low level. When the first over-discharge detection signal S1 switches from the low level to the high level and the reset signal R1 switches from the high level to the low level, the delay circuit 21 may begin counting. After the counting passes the end of a predetermined detection delay period tVdet2-1, the delay circuit 21 may switch the node N3a from the low level to the high level. After the counting passes the end of a predetermined detection delay period tVdet2-1b, the delay circuit 21 may switch the node N3b from the low level to the high level. tVdet2-1b may be a shorter period of time than tVde2-1.

When the second over-discharge detection signal S2 is set to the low level and the reset signal R2 is set to the high level, the delay circuit 22 may set the nodes N4a and N4b to the low level. When the second over-discharge detection signal S2 switches from the low level to the high level and the reset signal R2 switches from the high level to the low level, the delay circuit 22 may begin counting. After the counting passes the end of a predetermined detection delay period tVdet2-2, the delay circuit 22 may switch the node N4a from the low level to the high level. After the counting passes the end of the predetermined detection delay period tVdet2-2b, the delay circuit 22 may switch the node N4b from the low level to the high level. tVdet2-2b may be a shorter period of time than tVdet2-2.

If the low-voltage flag Nsoc may be set to the high level, the logic gate 51 may select tVdet2-1, generated by the delay circuit 21, as the detection delay period tVdet2. The logic gate 51 may output the logical AND of N3a's signal and Nsoc's signal. If the low-voltage flag Nsoc is set to the low level, the logic gate 52 may select tVdet2-1b, generated by the delay circuit 21, as the detection delay period tVdet2. The logic gate 52 may output the logical AND of N3a's signal and the inverted signal of Nsoc.

When the low-voltage flag Nsoc may be set to the high level, the logic gate 54 may select tVdet2-2, generated by the delay circuit 22, as the detection delay period tVdet2. The logic gate 54 may output the logical AND of N4a's signal and Nsoc's signal. When the low-voltage flag Nsoc is set to the low level, the logic gate 55 may select tVdet2-2b, generated by delay circuit 22, as the detection delay period tVdet2. The logic gate 55 may output the logical AND of N4b's signal and Nsoc's signal.

The OR gate 53 may output the logical OR of the output signal of the logic gate 51 and the output signal of the logic gate 52. The OR gate 56 may output the logical OR of the output signal of the logic gate 54 and the output signal of the logic gate 55. The OR gate 54 may output the logical OR of the output signal of the OR gate 53 and the output signal of the OR gate 56. The rest of the circuitry is the same as described above.

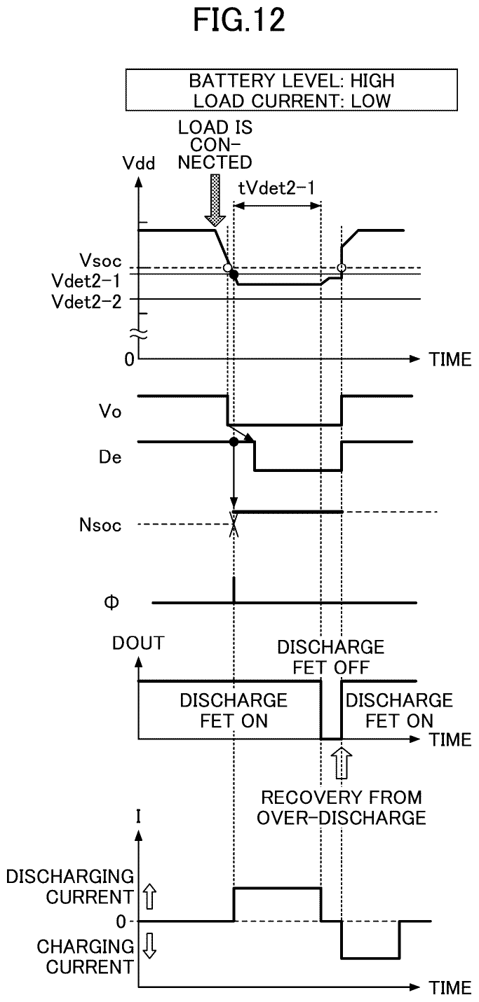

FIG. 12 shows examples of operation waveforms exhibited during discharge control by the integrated circuit of the third embodiment. FIG. 12 illustrates an example case in which the secondary battery 210 has a high battery level (that is, the power-supply voltage Vdd shortly before over-discharge is detected is greater than or equal to Vsoc) and a low load current. When the load 300 is connected to the system 503, the power-supply voltage Vdd may begin to drop. Because the secondary battery 210 has a high battery level and a low load current, the power-supply voltage Vdd may drop to or below Vdet2-1, but not all the way down to Vdet2-2. As the power-supply voltage Vdd drops to or below the threshold voltage Vsoc, the low-voltage detection signal Vo may drop from the high level to the low level. After the predetermined delay period tVsoc elapses, the delay signal De may switch from the high level to the low level.

If the power-supply voltage Vdd drops to or below the threshold voltage Vsoc, and, within the delay period tVsoc, drops further to or below Vdet2-1, a one-shot pulse Φ may be generated and the low voltage flag Nsoc may be set to the high level. As a result of this, when the detection delay period tVdet2-1, generated by the delay circuit 21, elapses, the discharge control circuit 221b may start the discharge control transistor TR2. As a result of this, discharging of the secondary battery 210 is stopped (see, for example, FIG. 12), ensuring proper protection of the secondary battery 210 from over-discharge.

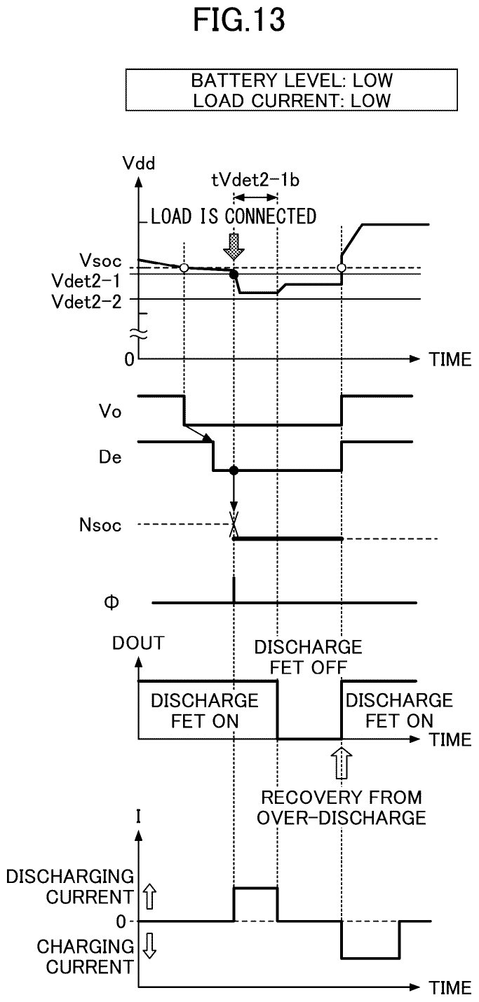

FIG. 13 shows examples of operation waveforms exhibited during discharge control by the integrated circuit of the third embodiment. FIG. 13 illustrates an example case in which the secondary battery 210 has a low battery level (that is, the power-supply voltage Vdd just before over-discharge is detected is lower than Vsoc) and a low load current. When the load 300 is connected to the system 503, the power-supply voltage Vdd may begin to drop. Because the secondary battery 210 has a low battery level and a low load current, the power-supply voltage Vdd may drop to or below Vdet2-1, but not all the way down to Vdet2-2. As the power-supply voltage Vdd drops to or below the threshold voltage Vsoc, the low-voltage detection signal Vo may drop from the high level to the low level. After the predetermined delay period tVsoc elapses, the delay signal De may switch from the high level to the low level.

After the power-supply voltage Vdd drops to or below the threshold voltage Vsoc and then the delay period tVsoc elapses, if the power-supply voltage Vdd drops to or below Vdet2-1, a one-shot pulse Φ may be generated, and the low-voltage flag Nsoc may be set to the high level. As a result of this, when the detection delay period tVdet2-1b (which is shorter than tVdet2-1), generated by the delay circuit 21, elapses, the discharge control circuit 221b may start the discharge control transistor TR2. As a result of this, discharging of the secondary battery 210 is promptly stopped (see, for example, FIG. 13), ensuring proper protection of the secondary battery 210 from over-discharge.

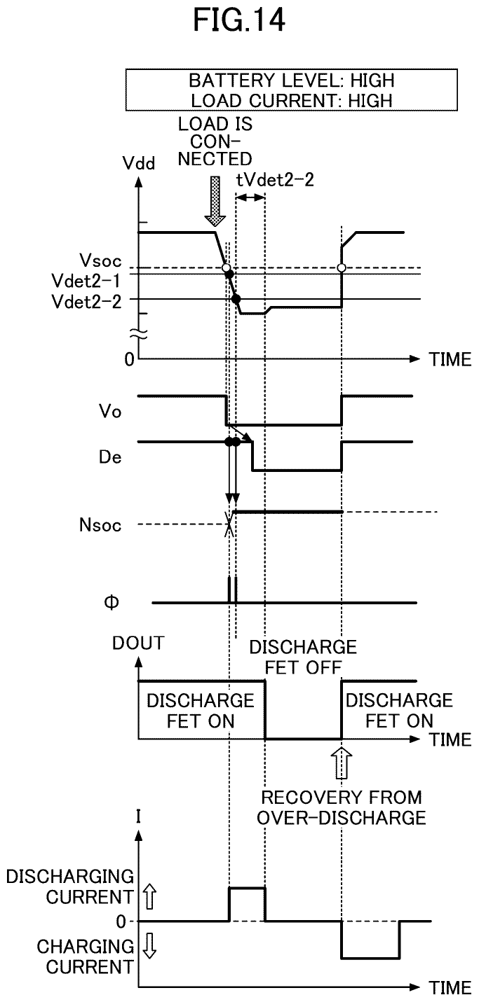

FIG. 14 shows examples of operation waveforms exhibited during discharge control by the integrated circuit of the third embodiment. FIG. 14 illustrates an example case in which the secondary battery 210 has a high battery level (that is, the power-supply voltage Vdd just before over-discharge is detected is greater than or equal to Vsoc) and a large load current. When the load 300 is connected to the system 503, the power-supply voltage Vdd may begin to drop. Because the secondary battery 210 has a high battery level and a large load current, the power-supply voltage Vdd may drop to or below Vdet2-2, which is lower than Vdet2-1. As the power-supply voltage Vdd drops to or below the threshold voltage Vsoc, the low-voltage detection signal Vo may drop from the high level to the low level. After the predetermined delay period tVsoc elapses, the delay signal De may switch from the high level to the low level.

If the power-supply voltage Vdd drops to or below the threshold voltage Vsoc, and, within the delay period tVsoc, drops further to or below Vdet2-2, a one-shot pulse Φ may be generated and the low voltage flag Nsoc may be set to the high level. As a result of this, when the detection delay period tVdet2-2, generated by the delay circuit 22, elapses, the discharge control circuit 221b may start the discharge control transistor TR2. As a result of this, discharging of the secondary battery 210 is stopped (see, for example, FIG. 14), ensuring proper protection of the secondary battery 210 from over-discharge. tVdet2-2 may be shorter than tVdet2-1.

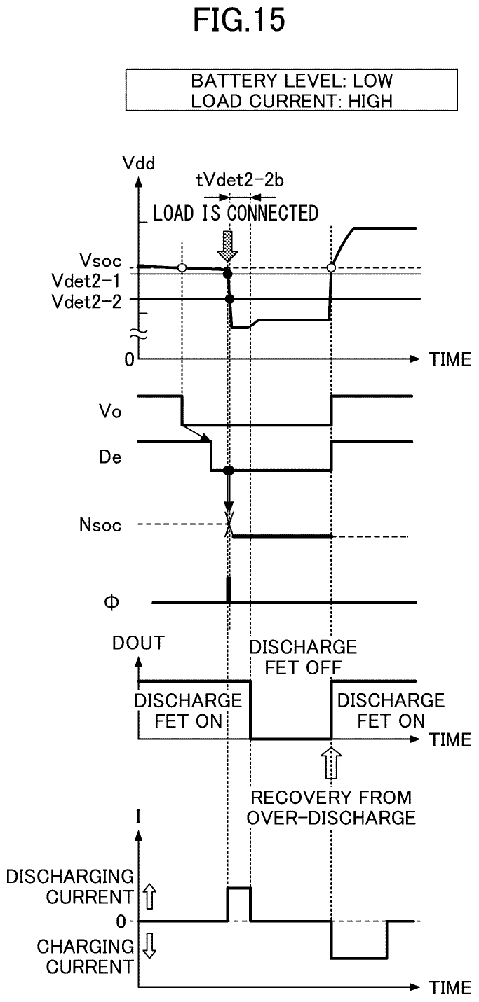

FIG. 15 shows examples of operation waveforms exhibited during discharge control by the integrated circuit of the third embodiment. FIG. 15 illustrates an example case in which the secondary battery 210 has a low battery level (that is, the power-supply voltage Vdd just before over-discharge is detected is lower than Vsoc) and a large load current. When the load 300 is connected to the system 503, the power-supply voltage Vdd may begin to drop. Because the battery level of the secondary battery 210 is low and the load current is large, the power-supply voltage Vdd may drop to or below Vdet2-2, which is lower than Vdet2-1. As the power-supply voltage Vdd drops to or below the threshold voltage Vsoc, the low-voltage detection signal Vo may drop from the high level to the low level. After the predetermined delay period tVsoc elapses, the delay signal De may switch from the high level to the low level.

After the power-supply voltage Vdd drops to or below the threshold voltage Vsoc and then the delay period tVsoc elapses, if the power-supply voltage Vdd drops to or below Vdet2-2, a one-shot pulse Φ may be generated, and the low-voltage flag Nsoc may be set to the high level. As a result of this, when the detection delay period tVdet2-2b (which is shorter than tVdet2-2), generated by the delay circuit 22, elapses, the discharge control circuit 221b may start the discharge control transistor TR2. As a result of this, discharging of the secondary battery 210 is promptly stopped (see, for example, FIG. 13), ensuring proper protection of the secondary battery 210 from over-discharge. tVdet2-2b may be shorter than tVdet2-1b.

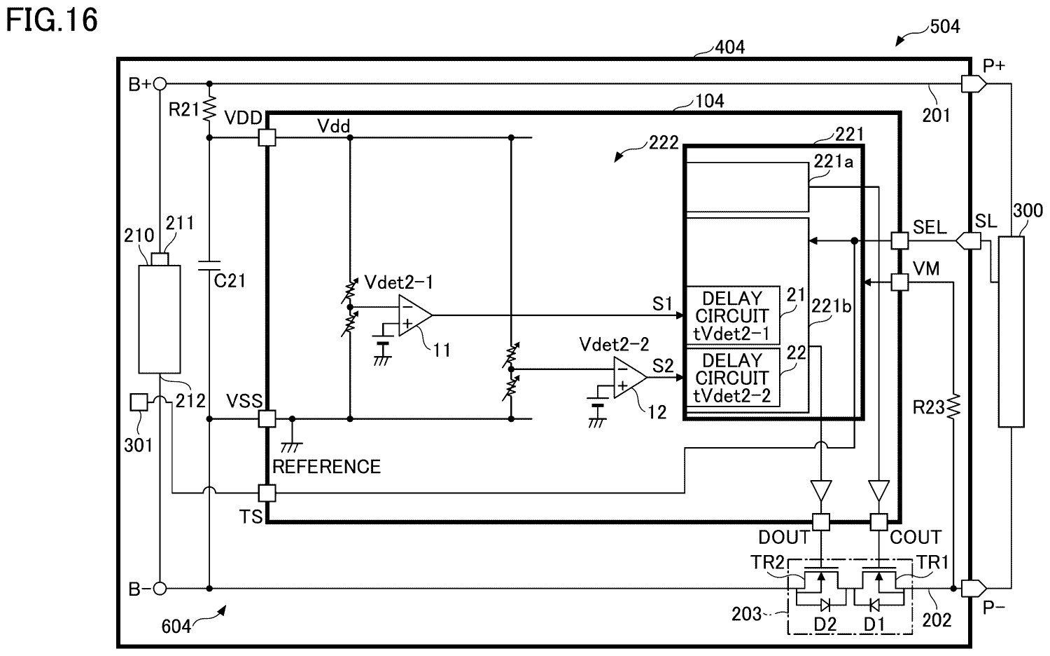

FIG. 16 is a circuit diagram showing an example system including an integrated circuit for protecting a secondary battery according to a fourth embodiment of the present disclosure. The following fourth embodiment incorporates the description given thus far by reference, so that parts, functions, and effects of the fourth embodiment that are the same or substantially the same as those of the above embodiments will not be described again. The fourth embodiment is different from the second embodiment in that, for example, it additionally includes a temperature sensor 301.

In FIG. 16, a system 504 may include a battery device 404 and electronic equipment 300. The battery device 404 may include a secondary battery 210 and a battery protection device 604. The battery protection device 604 may be, for example, a component having at least a substrate on which a protection IC 104 can be mounted. The battery device 404 may include an input terminal SL. The protection IC 104 may include an input terminal SEL, which can be connected with the input terminal SL.

The temperature sensor 301 may detect the temperature of the secondary battery 210 (or ambient temperature). The temperature sensor 301 may be included in the battery device 404. The temperature sensor 301 may be installed inside or outside the protection IC 104. The temperature sensor 301 may be, for example, a thermistor. The protection IC 104 may have a terminal TS connected to the temperature sensor 301. The protection IC 104 or the electronic equipment 300 may obtain the temperatures detected by the temperature sensor 301 from the terminal TS.

The protection IC 103 may select the specifics of over-discharge detection (e.g., the over-discharge detection voltage Vdet2 and the detection delay period tVdet2) based on temperature information detected by the temperature sensor 301. This use of temperature information in selecting the specifics of over-discharge detection may allow the discharge control circuit 221b to select the specifics of over-discharge detection more appropriately.

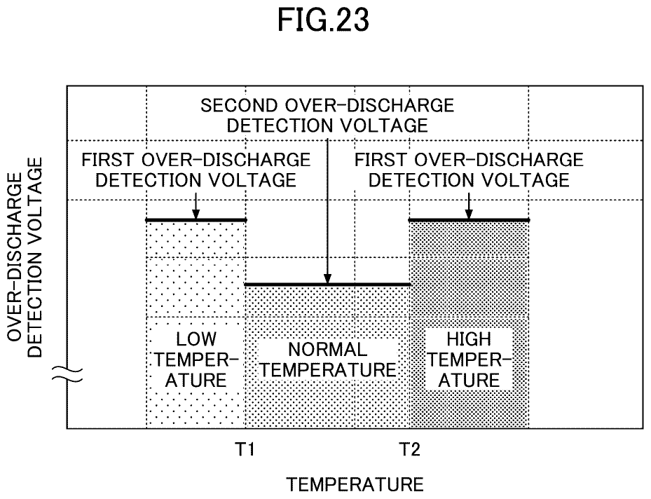

FIG. 23 shows examples of relationships between over-discharge detection voltages and temperatures. For example, as shown in FIG. 23, when a temperature between a first temperature T1 and a second temperature T2, inclusive, is detected by the temperature sensor 301 (e.g., normal temperature state), the discharge control circuit 221b may control the discharge control transistor TR2 based on the second condition A2. On the other hand, when a temperature lower than the first temperature T1 or higher than the second temperature T2 is detected by the temperature sensor 301 (e.g., high temperature or low temperature state), the discharge control circuit 221b may control the discharge control transistor TR2 based on the first condition A1. This allows the discharge control circuit 221b to change the over-discharge detection voltage Vdet2 and the detection delay period tVdet2 to values corresponding to varying temperatures detected by the temperature sensor 301.

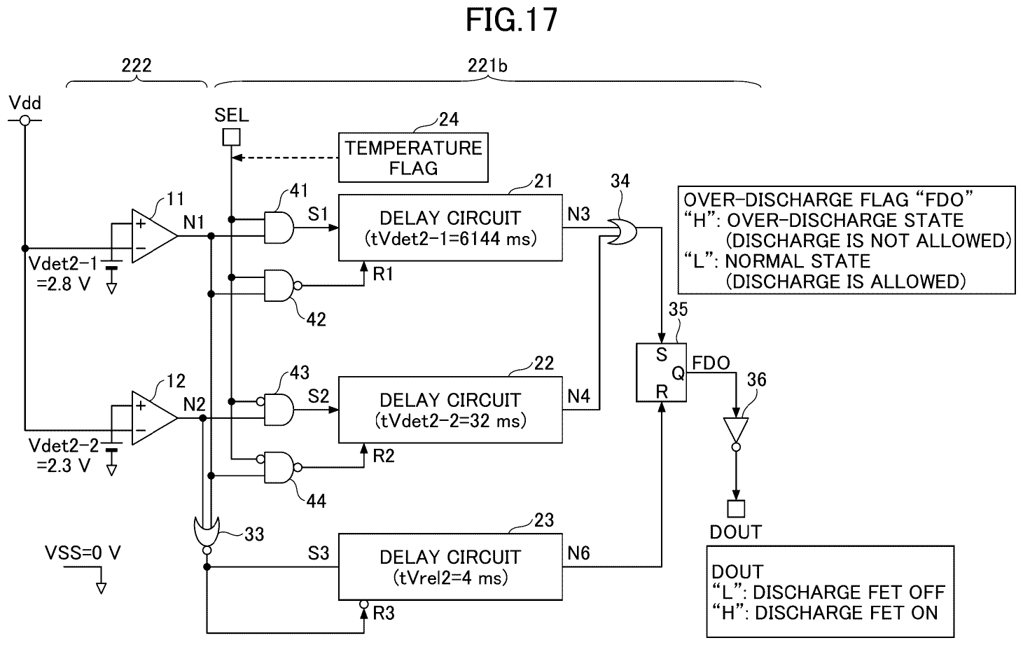

FIG. 17 is a circuit diagram showing an example of a discharge control circuit part in the integrated circuit according to the fourth embodiment. The discharge control circuit 221b may have delay circuits 21, 22, and 23, logic gates 41, 42, 43, and 44, a NOR gate 33, an OR gate 34, a latch circuit 35, and a NOT gate 36. These circuits may operate as in the second embodiment described above.

Information about the temperatures detected by the temperature sensor 301 may be input to an input terminal SEL as information received from outside equipment. Information about the temperatures detected by the temperature sensor 301 may also be input to a temperature flag 24 of the discharge control circuit 221b.

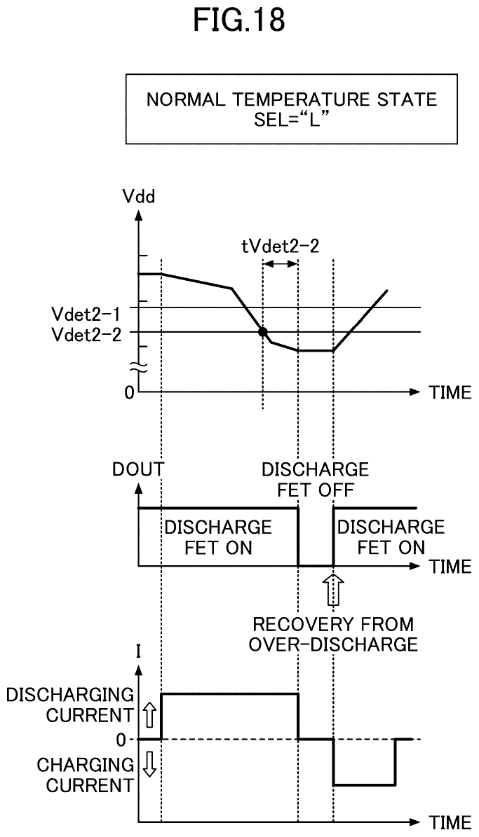

For example, while low-level temperature information indicating a normal temperature state is input to the input terminal SEL or the temperature flag 24, the discharge control circuit 221b may control the discharge control transistor TR2 based on a second condition A2. In this case, as in the first embodiment, if the state in which the power-supply voltage Vdd is lower than Vdet2-2 (which is lower than Vdet2-1) lasts the detection delay period tVdet2-2 (which is shorter than tVdet2-1), the delay circuit 22 may stop discharging the secondary battery 210 (see, for example, FIG. 18). This can quickly stop discharging of the secondary battery 210, ensuring proper protection of the secondary battery 210 from over-discharge.

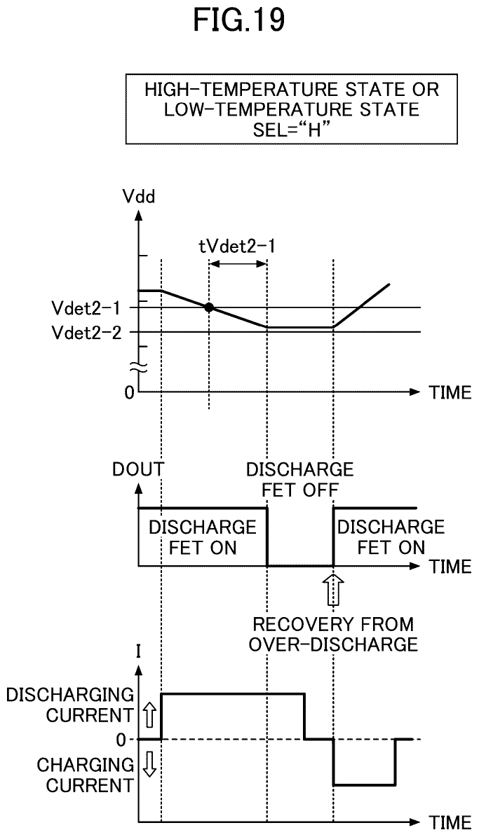

On the other hand, referring again to FIG. 17, while high-level temperature information, which indicates a high temperature state or a low temperature state, is input to the input terminal SEL or the temperature flag 24, the discharge control circuit 221b may control the discharge control transistor TR2 based on the first condition A1. In this case, again, as in the first embodiment, if the state in which the power-supply voltage Vdd is lower than Vdet2-1 lasts the detection delay period tVdet2-1, the delay circuit 21 may stop discharging of the secondary battery 210 (see, for example, FIG. 19). This ensures proper protection of the secondary battery 210 from over-discharge.

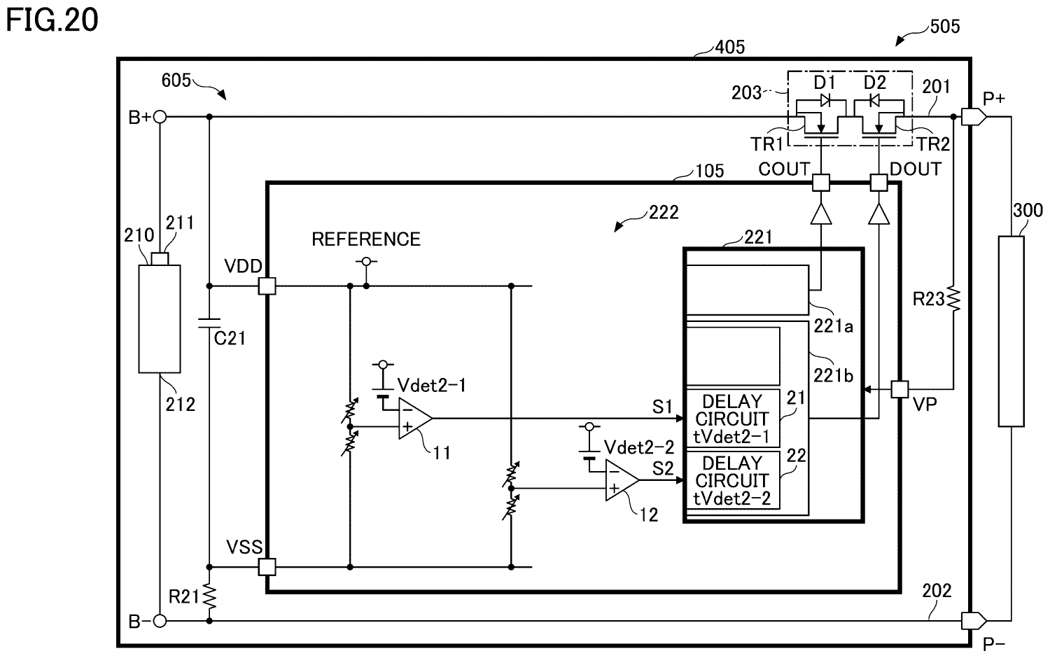

FIG. 20 is a circuit diagram showing an example system including an integrated circuit for protecting a secondary battery according to a fifth embodiment of the present disclosure. The following fifth embodiment incorporates the description given thus far by reference, so that parts, functions, and effects of the fifth embodiment that are the same or substantially the same as those of the above embodiments will not be described again. The fifth embodiment may be different from the first embodiment in that, for example, a switch circuit 203 is provided on the high-side power-feed line 201. As an alternative of the fifth embodiment, a structure combined with the structure of the second, the third, or the fourth embodiment may be employed as well.

In FIG. 20, a system 505 may include a battery device 405 and electronic equipment 300. The battery device 405 may include a secondary battery 210 and a battery protection device 605. The battery protection device 605 may be, for example, a component having at least a substrate on which a protection IC 105 can be mounted. A terminal VP may have the same function as that of the terminal VM in the first embodiment.

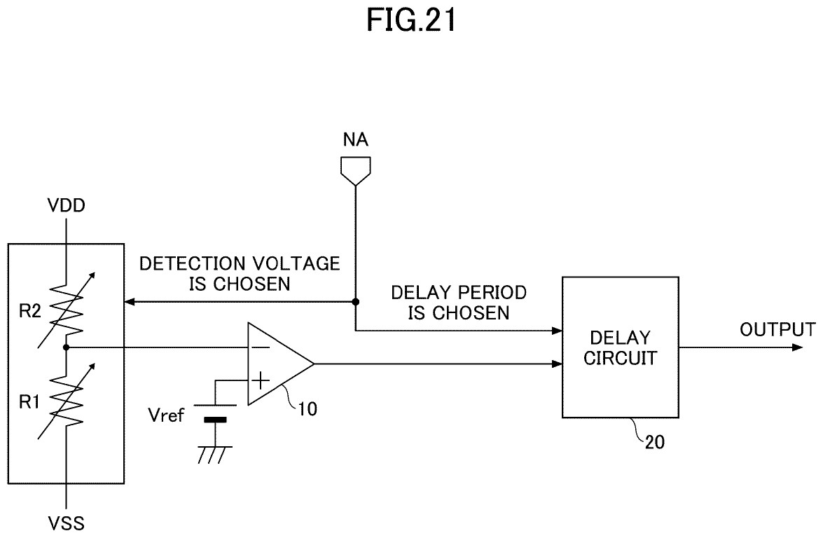

FIG. 21 shows an example of an alternative discharge control circuit part. A discharge control circuit 221b in the protection IC may have an input terminal SEL, which is the same as that described earlier, and a node NA, where information about a temperature flag 24 may be input. The discharge control circuit 221b may change the ratio of division of the power-supply voltage Vdd between the resistor R1 and the resistor R2 of the detection circuit 222, or change the length of the detection delay period tVdet2 generated by the delay circuit 20, depending on the state the node NA is in. The discharge control circuit 221b may thus change the ratio of division of the power-supply voltage Vdd between the resistors R1 and R2 of the detection circuit 222 depending on the state of the node NA, thereby switching the over-discharge detection voltage Vdet2 to different voltages. This may allow the circuitry for changing the over-discharge detection voltage Vdet2 (=(R1+R2)×(R1/Vref)) to be more compact.

Although embodiments of the present disclosure have been described above, these embodiments only show examples and do not limit the scope of the present disclosure in any way. The embodiments disclosed herein may be carried out in a variety of other forms, and various combinations, omissions, substitutions, alterations, and so forth may be made without departing from the spirit and scope of the present disclosure. These embodiments, as well as their modifications, may be included within the scope and spirit of the present disclosure, as well as the accompanying claims and their equivalents.

For example, the positions of the charge control transistor TR1 and the discharge control transistor TR2 may be switched, as opposed to their respective positions illustrated in the drawings. Furthermore, the switch circuit 203 may be built in a protection IC.

What is claimed is:

1. An integrated circuit configured to protect a secondary battery, the integrated circuit comprising:
a power-supply terminal connectable with a positive terminal of the secondary battery;
a ground terminal connectable with a negative terminal of the secondary battery; and
a control circuit configured to control a discharge-stop circuit to stop discharging of the secondary battery,
wherein, in response to a power-supply voltage between the power-supply terminal and the ground terminal of the integrated circuit being greater than or equal to a first threshold voltage, the first threshold voltage being higher than a second threshold voltage, the control circuit carries out a first operation,
wherein, in response to an event in which a first condition in which the power-supply voltage is lower than the first threshold voltage lasts a first period of time, the control circuit starts the discharge-stop circuit, and
wherein, in response to an event in which a second condition in which the power-supply voltage is lower than the second threshold voltage lasts a second period of time, the second period of time being shorter than the first period of time, the control circuit starts the discharge-stop circuit.

2. The integrated circuit according to claim 1, further comprising an input terminal configured to receive information from outside equipment,
wherein, while the input terminal receives first information from the outside equipment, the control circuit controls the discharge-stop circuit based on the first condition regardless of the second condition, and
wherein, while the input terminal receives second information from the outside equipment, the second information being different information from the first information, the control circuit controls the discharge-stop circuit based on the second condition regardless of the first condition.

3. The integrated circuit according to claim 1, wherein, when, after the power-supply voltage drops to or below a third threshold voltage and a third period of time elapses, the power-supply voltage falls below the second threshold voltage, the third threshold voltage being higher than the first threshold voltage, the control circuit starts the discharge-stop circuit after a fourth period of time elapses, the fourth period of time being shorter than the second period of time.

4. The integrated circuit according to claim 3, wherein, when, after the power-supply voltage drops to or below the third threshold voltage and the third period of time elapses, the power-supply voltage falls below the first threshold voltage in conjunction with the power-supply voltage being at or above the second threshold voltage, the control circuit starts the discharge-stop circuit after a fifth period of time elapses, the fifth period of time being shorter than the first period of time.

5. The integrated circuit according to claim 1,
wherein the control circuit controls the discharge-stop circuit based on the second condition when a temperature sensor detects a temperature between a first temperature and a second temperature, inclusive, and
wherein the control circuit controls the discharge-stop circuit based on the first condition when the temperature sensor detects a temperature that is lower than the first temperature or higher than the second temperature.

6. The integrated circuit according to claim 2,
wherein the first information indicates that electronic equipment where the secondary battery feeds power is in sleep mode, and
wherein the second information indicates that the electronic equipment is in active mode.

7. The integrated circuit according to claim 2,
wherein the first information indicates that the secondary battery is in a first state of charge, and
wherein the second information indicates that the secondary battery is in a second state of charge, the second state of charge corresponding to a lower battery level than the first state of charge.

8. A battery device comprising:
a secondary battery;
a discharge-stop circuit configured to stop discharging of the secondary battery; and
an integrated circuit configured to protect the secondary battery,
wherein the integrated circuit includes:
a power-supply terminal connectable with a positive terminal of the secondary battery;
a ground terminal connectable with a negative terminal of the secondary battery; and
a control circuit configured to control the discharge-stop circuit,
wherein, in response to a power-supply voltage between the power-supply terminal and the ground terminal of the integrated circuit being greater than or equal to a first threshold voltage, the first threshold voltage being higher than a second threshold voltage, the control circuit carries out a first operation,
wherein, when a first condition in which the power-supply voltage is lower than the first threshold voltage lasts a first period of time, the control circuit starts the discharge-stop circuit, and
wherein, when a second condition in which the power-supply voltage is lower than the second threshold voltage lasts a second period of time, the second period of time being shorter than the first period of time, the control circuit starts the discharge-stop circuit.

9. The battery device according to claim 8, wherein the secondary battery is a lithium ion battery with a silicon anode.
